(19) United States
(12) Patent Application Publication
(10) Pub. No.: US 2007/0120328 A1
(43) Pub. Date: May 31, 2007

(54) Seal ring and mechanical seal device for jet engines

(76) Inventors: Peter Haselbacher, Geretsried (DE); Thomas Keller, Geretsried (DE)

Correspondence Address: EDWARDS ANGELL PALMER & DODGE LLP, P.O. BOX 55874, BOSTON, MA, 02205, US

(21) Appl. No.: 10/565,872

(22) PCT Filed: Jul. 8, 2004
(86) PCT No.: PCT/EP04/07524

§ 371 Date: Jan. 23, 2006

(30) Foreign Application Priority Data
Jul. 23, 2003 (DE) 20311346.2

(51) Int. Cl. F16J 15/34

(52) U.S. Cl. 277/404

(57) ABSTRACT

A seal ring (1) of a mechanical face seal device for jet engines that is designed for rotation in common with an engine shaft is formed of a composite material comprising a fibre-reinforced ceramic material. The reinforcing fibres may be carbon or SiC fibres, and the ceramic material may be a SiC material. Furthermore, composite seal rings of this type can be provided with pumping structures (20) in the seal face. Brittle fractures of the SiC matrix do not occur so that the seal ring is at least equal to one such consisting of a steel material in regard to the safety function thereof. However, the wear is substantially less and furthermore, there is no need to provide cooling means for the composite seal ring, whereas the known steel seal rings must contain cooling channels through which a cooling agent is caused to flow for cooling purposes.

The invention relates to a seal ring of a mechanical face seal device for jet engines provided for rotation in common with an engine shaft, particularly for use in aircraft construction.

Insofar as mechanical face seals are used for sealing turbine shafts and other shafts in aircraft jet engines, an essential requirement for such seals is that sufficiently ductile materials be provided in order to prevent brittle fractures due to the high centrifugal forces effective thereon and thus the danger associated therewith of damage to the engine parts caused by flying fragments. In meeting this requirement, while one is comparatively free in regard to the choice of a suitable material for the stationary seal ring, but until now it has always been necessary for a steel material to be used exclusively for the rotary seal ring because of the adequate ductility of the steel material and thus lack of tendency to brittle fracture. Consequently, the rotary seal rings in the known mechanical face seals utilised in aircraft engines are correspondingly heavy especially as the seal rings used in aircraft engines must have comparatively large dimensions. On the other hand, lightweight construction is an absolutely essential design necessity in the field of aircraft manufacture and particularly in that of engine construction, whereby as an approximate figure it is considered that a weight reduction of one kilogram in a jet engine entails development costs of e.g. 10⁶ EUR. When viewed in this light, the pure material costs play a subordinate role.

An object of the invention is to obtain a substantial reduction in weight of mechanical face seals used in aircraft jet engines without loss of safety thereof, and in particular without causing brittle fractures whilst at least maintaining the other previous operating conditions.

In accordance with the invention, this object is achieved and thus an urgent need in the field of aircraft jet engine construction is met in that, for application in this field, the rotary seal ring of a mechanical face seal device is formed of a composite material comprising a fibre-reinforced ceramic material. Hereby, it is preferred to use a composite material incorporating reinforcing fibres in the form of carbon or SiC fibres which are embedded in a SiC ceramic material. A composite material of this type has adequate strength and ductility so as to ensure equally good if not even better protection from brittle fractures as compared with steel seal rings under the operating conditions prevailing in jet engines which are characterised in particular by the high rotational speeds of the shafts that are to be sealed. In addition, the wear properties are improved because of the inherent abrasion resistance of the SiC matrix material of the composite seal rings and a simplification of the construction of a mechanical face seal device provided therewith is obtained since one can dispense with cooling measures that have to be provided for steel seal rings. However, a primary advantage of the composite seal rings according to the invention is the substantially lesser weight thereof compared with seal rings made from a steel material, whereby considerable development costs can be saved. Further advantageous embodiments of the composite seal ring are specified in the subclaims. While the use of carbon fibre reinforced SiC ceramics for brake disks has already been proposed in the automobile industry, here it is primarily the temperature resistance and abrasion resistance of the composite material that comes to the fore. The behaviour of such composite materials at high rotational speeds was not investigated. A gas-lubricated mechanical face seal device for jet engines in accordance with the invention comprises at least one pair of cooperating seal rings, of which one is designed for non-rotational mounting on a stationary component such as the engine housing, and the other for rotation in common with an engine shaft, whereby in accordance with the invention, there is provided a pairing of materials for the seal rings which comprises a friction minimizing material such as a carbon material for the stationary seal ring and a composite material according to the invention for the rotary seal ring.

The invention is described in more detail hereinafter with the aid of exemplary embodiments and the drawings. In the drawings:

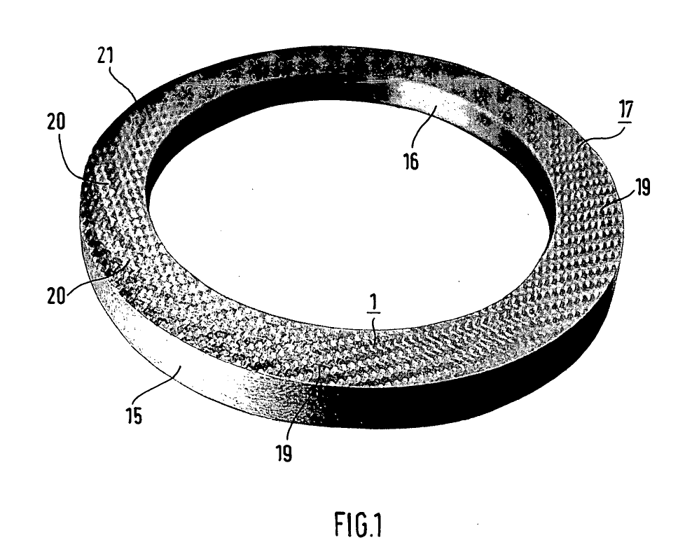

FIG. 1 is a photographic illustration of a rotary seal ring in accordance with the invention when viewed on one of its end faces,

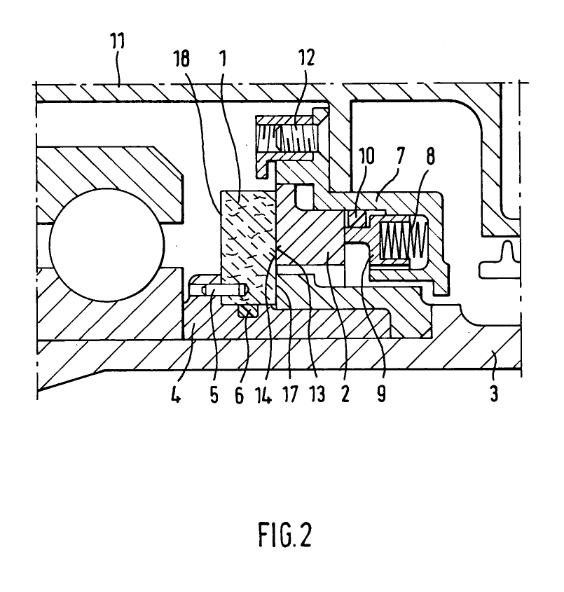

FIG. 2 is a sectional view of a mechanical face seal device equipped with a rotary seal ring in accordance with the invention in its state of installation in a schematically indicated jet engine (partial view).

Hereinafter, reference will first be made to FIG. 2. The mechanical face seal device shown therein comprises a pair of cooperating seal rings 1, 2, of which the one seal ring 1 is formed in accordance with the present invention and will subsequently be described in greater detail. This seal ring 1 is intended for rotation in common with an engine shaft 3 or a bushing 4 seated thereon. For the purposes of transmitting torque from the bushing 4 to the seal ring 1, there is provided a driver arrangement 5 which may be in the form of one or more driver pins that extend from the bushing 4 into borings in the seal ring 1 aligned therewith. Other driver arrangements could likewise be envisaged. The seal ring 1 is sealed with respect to the bushing 4 by a suitable secondary seal such as is indicated by 6.

The other seal ring 2 is held non-rotatably with respect to a seal housing 7 but is moveable in the axial direction. A biasing mechanism 8 in the form of one or more axial compression springs, which are supported at one end on the seal housing 7 and on a power transmission member 9 that is axially moveable therein at the other end, is provided in order to urg the seal ring 2 against the rotary seal ring 1 under an axial bias force. A secondary seal for sealing the seal ring 2 with respect to the seal housing 7 is indicated by 10. The seal housing 7 can be mounted in an appropriate manner to an engine casing 11 e.g. it can be bolted thereto as is indicated by 12.

The seal rings 1, 2 have seal faces 13, 14 facing each other between which a sealing gap is formed when the device is operative in order to seal a region peripherally outward of the seal faces 13,14 with respect to a region peripherally inward thereof. The formation of the sealing gap can be assisted by pumping structures 20 in one or both seal faces 13,14, preferably in the seal face 13 of the rotary seal ring 1. Reference can be made e.g. to BURGMANN, Gasgeschmierte Gleitringdichtungen, self published 1997, pages 16 to 23 in regard to further details of the construction and the effect of such pumping structures 20.

The non-rotational seal ring preferably consists of a carbon material because of the friction-minimizing properties and the adequate thermal and mechanical stability or strength thereof. Suitable carbon materials are described in BURGMANN, ABC der Gleitringdichtung, self published 1988, pages 269-270. Other suitable friction-minimizing materials could also be envisaged for the non-rotational seal ring 2.

In the mechanical face seal device according to the invention, the seal ring pairing does not make use of a steel material which was until now considered necessary at least for the rotary seal ring 1 for reasons of reliability. Rathermore, the rotary seal ring 1 in accordance with the invention consists of a metal-free composite material which is formed of a fibre-reinforced ceramic material.

FIG. 1 shows an embodiment of a rotary seal ring 1 formed of the composite material. Accordingly, the seal ring 1 has a preferably rectangular cross section with outer and inner peripheries 15, 16 and planar front and rear end faces 17, 18 of which only the front end face 17 is shown in FIG. 1. The seal face 13 is formed on at least a sub-portion of the end face 17. As has been referred to hereinbefore, peripherally distributed pumping structures 20 (only some are shown here) can be formed in the portion of the end face 17 providing the seal face 13 by using known techniques, e.g. laser beam cutting. As can be seen here, the pumping structures 20 run out into the inner periphery 16 in the case where the medium is applied to the interior of the seal ring 1. If the medium is applied to the exterior thereof, they run out into the outer periphery 15. In either case, the pumping structures 20 extend from the respective periphery 15 or 16 towards the other relevant periphery and terminate at a suitable distance therefrom such as to leave a dam portion 21 which is free of pumping structures 20.

The seal ring 1 in accordance with the preferred embodiment of the invention comprises carbon reinforcing fibres which are embedded in a silicon carbide (SiC) matrix material. These fibres are characterised by their high thermal stability and simultaneous high unidirectional tensile strength, whereby they exhibit substantially greater ductility in comparison with the SiC matrix material. The ductility of the carbon fibres effectively serves to counter the natural inclination of SiC to brittle fracture, in that the predominantly mechanical loads acting on a seal ring 1 made of such a composite material is essentially accommodated by the reinforcing fibres whilst relieving load on the SiC matrix material. The high abrasion resistance of SiC remains practically unimpaired hereby.

The carbon fibres can be provided in the SiC composite material in an aligned or unaligned manner.

In the first case, this may be in the form of filaments or rovings of carbon fibres that are wound in layers into a tubular shape in correspondence with a certain pattern, whereby the filaments in one layer can cross the filaments of a neighbouring layer, or it may be in the form of prefabricated superimposed layers of scrim or fabric consisting of aligned carbon fibre filaments embedded in the SiC composite material as is indicated by 19 in FIG. 1. The alignment of the filaments shown in FIG. 1 is not binding. Other suitable alignments of the filaments could also be envisaged, e.g. a predominantly circumferential alignment.

A SiC composite material reinforced by aligned carbon fibres is characterised by its particularly high mechanical strength in the direction of the fibres and is therefore used preferentially for seal rings 1 which are intended to be employed in mechanical face seal devices in the high rotational speed region of a jet engine where high to very high centrifugal forces can act on the seal ring 1, particularly as the radial dimensions of the seal rings 1 are comparatively large and may have an average diameter of e.g. 150 mm and more.

Furthermore, at least the front end face 17 of the seal ring 1 providing the seal face 13 may preferably be covered with a surface layer (not shown) consisting of a SiC composite material reinforced with carbon fibres of comparatively short length wherein the carbon fibres are present in an unaligned form. The surface layer can have a thickness of between 0.1 and 1.0 mm, preferably 0.25 and 0.5 mm. The pumping structures 20 are formed in the surface layer. The surface layer prevents any possible sticking-out or fraying of the aligned carbon fibres in the superimposed layers of scrim on the end face 17 of the seal ring 1. If so desired, a surface layer of this type could also be provided on the opposite end face 18 of the seal ring 1.

In the case of a seal ring 1 consisting of a SiC composite material reinforced with unaligned filaments of carbon fibres, its mechanical behaviour is essentially direction-independent. Due to their lower mechanical strength, these seal rings 1 are suitable primarily for use in the low rotational speed region of a jet engine where lower centrifugal forces come into effect. Insofar as the length of the carbon fibres is equal to or greater than 5 mm, and preferably amounts to between 15 and 25 mm, it is ensured that the mechanical properties will suffice for such applications.

The carbon fibres should have a diameter of less than 15 μm, preferably of between 2 and 12 μm, since improved mechanical properties of the fibres accompany when reducing the diameter thereof.

Furthermore, the proportion of carbon fibres in the SiC composite material should amount to between 45 and 65, preferably to between 50 and 60 volume %.

Furthermore, it has been found that silicon fibres can also be used in place of carbon fibres as a reinforcing means in a composite material based on a SiC ceramic material.

### EXAMPLE

A composite material comprising a reinforcing means in the form of aligned carbon fibres and a SiC matrix was made using a known process, in that a scrim of carbon fibres having an average length of 70 mm, a powder consisting of carbon and a carbon resin were layered into a pressable mass and the layered arrangement was compacted into shape. Subsequently, a carbonising process was carried out at a temperature of approximately 900° C. whereby the resin was converted into carbon. A porous structure incorporating cavities thus resulted. Liquid silicon was forced into the structure and was converted into SiC at temperatures of approximately 1500° C., whereby the carbon fibres were embedded in the SiC. A typical blank for the seal ring 1 manufactured using this process has a density of 1.45 Kg/dm³, a modulus of elasticity of 53 KN/mm², a tensile strength of 265 KN/mm² and a thermal expansion of 1×10^{6 -}1/K. The proportion of fibre amounted to 55 Vol. %. A seal ring 1 having the following dimensions was cut out from the thus obtained composite material: Internal diameter: 130 mm, external diameter: 170 mm, thickness 13 mm. The ductility of the seal ring 1 was comparable with that of a known seal ring made of a steel material. The weight of the composite seal ring amounted to only about ⅕ of that of a steel seal ring.

Should it be desirable to provide a surface layer on one of the end faces 17, 18 of the seal ring 1 as described hereinbefore, a thin layer of a mixture of unaligned carbon fibres, a powder consisting of carbon and a carbon resin are applied to the end face in addition to the layered scrim of aligned carbon fibres and then processed together with the scrim layer in the manner explained above.

Tests in line with standard usage on a gas-lubricated mechanical face seal device comprising a rotary seal ring in the form of a composite seal ring according to the invention incorporating spirally extending pumping structures in its seal face showed no brittle fractures of the SiC matrix over the entire extended test period so that the seal ring is at least equal to one consisting of a steel material in regard to the safety function thereof. The wear however was substantially less, and furthermore no cooling of the composite seal ring needed to be provided, whereas for the purposes of cooling the known steel seal rings they must contain cooling channels through which a cooling medium can flow.

1. A seal ring a mechanical face seal device for jet engines adapted for rotation in common with an engine shaft, wherein said seal ring is formed of a composite material comprising a fibre-reinforced ceramic material.

2. The seal ring according to claim 1, wherein the reinforcing fibres are selected from a group of reinforcing fibres comprising carbon and SiC fibres.

3. The seal ring according to claim 1, wherein the ceramic material comprises a SiC material.

4. The seal ring according to claim 1, wherein the proportion of reinforcing fibre in the composite material amounts to between 45 and 65 volume %, preferably to between 50 and 60 volume %.

5. The seal ring according to claim 1, wherein the composite material comprises unaligned reinforcing fibres having a length of more than 5 mm, preferably of between 15 and 25 mm.

6. The seal ring according to claim 1, wherein the composite material comprises aligned reinforcing fibres.

7. The seal ring according to claim 1, wherein the diameter of the reinforcing fibres amounts to less than 15 μm, preferably to between 2 and 12 μm.

8. The seal ring according to claim 6, wherein a fabric of reinforcing fibres is provided.

9. The seal ring according to claim 6, wherein there is provided a fibre reinforcement which is produced by a fibre filament winding process.

10. The seal ring according to claim 6, wherein a surface layer consisting of a fibre-reinforced SiC composite material is provided on at least one of the opposite end faces of the seal ring, whereby the reinforcing fibres in the surface layer are unaligned.

11. The seal ring according to claim 10, wherein the thickness of the surface layer amounts to between 0.1 and 1.0 mm, preferably between 0.25 and 0.5 mm.

12. The seal ring according to claim 1, wherein a seal face having pumping structures formed therein is formed in at least one of the end faces of the seal ring.

13. A mechanical face seal device for jet engines comprising at least one pair of cooperating seal rings, of which one is designed for non-rotational mounting on a stationary component and the other for rotation in common with an engine shaft, and further including a pairing of materials for the seal rings which comprises a friction minimizing material. for the non-rotational seal ring and a composite material consisting of a fibre-reinforced ceramic material for the rotary seal ring.

14. The mechanical face seal device for jet engines according to claim 13, wherein the composite material is a SiC composite material reinforced with carbon or SiC fibres.

15. The mechanical face seal device for jet engines according to claim 13, wherein the friction-minimizing material is a carbon material.

16. The mechanical face seal device for jet engines according to claim 13, wherein, for use in a low-pressure region of the jet engine, the composite material comprises unaligned reinforcing fibres having a length of more than 5 mm, preferably of between 15 and 25 mm.

17. The mechanical face seal device for jet engines according to claim 13, wherein, for use in a high pressure region of the jet engine, the composite material comprises aligned reinforcing fibres.

18. The mechanical face seal device for jet engines according to claim 17, wherein a surface layer consisting of a fibre-reinforced SiC composite material is provided on at least that one of the opposite end faces of the rotary seal ring on which a seal face is formed, whereby the reinforcing fibres of the surface layer are unaligned.

19. The mechanical face seal device for jet engines according to claim 13, wherein pumping structures are formed in at least one of the seal faces of the seal rings.

20. The seal ring according to claim 7, wherein a surface layer consisting of a fibre-reinforced SiC composite material is provided on at least one of the opposite end faces of the seal ring, whereby the reinforcing fibres in the surface layer are unaligned.

21. The seal ring according claim 1, wherein a seal face having pumping structures formed therein is formed in at least one of the end faces of the seal ring provided with a surface layer thereon.
